(19) United States
(12) Patent Application Publication
(10) Pub. No.: US 2022/0125267 A1
(43) Pub. Date: Apr. 28, 2022

(54) CLEANER

(71) Applicant: Koki Holdings Co., Ltd., Tokyo (JP)

(72) Inventors: Hiroyuki TAGAMI, Ibaraki (JP); Naoto ICHIHASHI, Ibaraki (JP)

(73) Assignee: Koki Holdings Co., Ltd., Tokyo (JP)

(21) Appl. No.: 17/312,930

(22) PCT Filed: Nov. 29, 2019
(86) PCT No.: PCT/JP2019/046790

§ 371 Date: Jun. 10, 2021

(30) Foreign Application Priority Data
Dec. 13, 2018 (JP) 2018-233749
Mar. 15, 2019 (JP) 2019-048175

(51) Int. Cl. A47L 9/28; A47L 9/00; A47L 5/24; A47L 9/32

(52) U.S. Cl. CPC A47L 9/2884; A47L 9/322; A47L 5/24; A47L 9/0081

(57) ABSTRACT

As a result of the rotation of a fan (65) driven by a motor (40) inside a housing (2), dust-laden air that has been sucked in from a nozzle (92) passes through a filter device (95), flows as in (C1, C2), and is discharged from a discharge port (30) to the outside of the housing (2). Viewed in the direction of the axis (A1) of the motor (40): an air intake port (10) is located in front of the motor (40); a battery pack (100) is located behind the motor (40); and a handle (4) is located behind the motor (40). The air exhaust port (30) is located between the handle (4) and the battery pack (100) and is provided behind the center position of the battery pack (100) in the axis (A1) direction.

### BACKGROUND

### Technical Field

The present invention relates to a portable cleaner using a battery, in particular to a portable cleaner in which arrangement of air exhaust paths and air exhaust ports is improved.

### Related Art

In a conventional portable cleaner, a motor and a dust collection fan which is rotated by the motor are built in a housing, and in front of the housing, a dust case is disposed which stores powder dust and the like that have been sucked in by the rotation of the dust collection fan. In the dust case, a suction port for sucking the powder dust and the like is arranged, and inside the dust case, a filter device is arranged for capturing only the dust from dust-laden air that has been sucked in. In a part of the housing which accommodates the motor, a handle for a worker to grip with one hand is formed, and on the handle, a switch for starting and stopping the motor is arranged. In the housing, a battery mounting portion for a battery pack to be mounted in is further formed. As this portable cleaner, for example, technology in Patent literature 1 is known.

In the above-described cleaner, if the switch is turned on and the motor is started, the dust collection fan is rotated and a sucking force is generated in the suction port. If the worker starts dust collection work, from the powder-dust-laden air sucked in from the suction port, only the dust is separated by a filter medium of the filter device and stays inside the dust case. The air passing through the filter device is sucked from the dust case into the motor housing in which the dust collection fan is accommodated, flows surrounding the motor, and is discharged to the outside from air exhaust ports which are formed in the motor housing.

### LITERATURE OF RELATED ART

### Patent Literature

Patent literature 1: International Publication No. WO2016/052267

### SUMMARY

### Problems to be Solved

In the cleaner, reduction in operation sound, particularly reduction in sound generated from the fan is desirable. In a cleaner in Patent literature 1, the motor is arranged in the neighborhood of the center of a great-diameter portion of the motor housing, and the air exhaust ports, which is used for discharging air exhaust wind passing through the dust collection fan to the outside of the housing, is arranged in the vicinity of the motor in front of the handle. As a method for making the sound caused by the rotation of the fan difficult to transmit to the outside, it is considered that the air exhaust ports are set to be smaller. However, if the air exhaust ports are set to be smaller, the flow rate of air exhaust will be reduced, and dust collection capacity of a cleaner will decrease.

The present invention has been made in view of the above circumstances, and an object of the present invention is to provide a cleaner which can sufficiently ensure the flow rate of the exhaust air stream, maintain the dust collection capacity, and reduce the noise caused by the exhaust air stream. Another object of the present invention is to provide a cleaner which uses a detachable battery pack and has air exhaust ports formed behind a battery mounting portion. Still another object of the present invention is to provide a cleaner which uses internal spaces of both the battery mounting portion and a handle as wind paths to the air exhaust ports.

### Means to Solve Problems

Typical characteristics in the invention disclosed in the application are described as follows. According to one characteristic of the present invention, a cleaner has: a cylinder-shaped housing; a motor which is held inside the housing in a way that an output shaft faces the longitudinal direction; a fan which is fixed to the output shaft and is used for generating sucking force; and a battery pack which is fixed to the housing in a freely detachable way and supplies electric power to the motor. The following components are formed in the housing: an air intake port from which an airflow generated by rotation of the fan enters the inside of the housing; air exhaust ports from which the airflow is discharged to the outside of the housing; and a handle which is gripped by a worker. Here, the air intake port is located in front of the motor in the axis direction of the output shaft, the battery pack is located behind the motor in the axis direction, the handle is located behind the motor in the axis direction, and the air exhaust ports are located between the handle and the battery pack. A dust case having a suction port that sucks powder dust is arranged in front of the fan of the housing, and a connection portion to which the battery pack is connected is arranged at the back of the housing. Besides, the air exhaust ports are arranged behind a center position of the battery pack in the axis direction.

According to another characteristic of the present invention, behind the motor in the housing, a substantially D-shaped is formed in a side view. With the D-shaped cavity therebetween, one side (for example, an upper-side) is the handle to be gripped by the worker, and the other side (for example, a lower-side) forms the connection portion for the battery pack. The handle and a back-end of the connection portion are connected. In addition, a space behind the motor of the housing is a first flow path of the airflow for guiding air, which is sucked into the housing from the dust case, to the air exhaust ports by the fan, and an internal space of the handle is a second flow path of the airflow for guiding the air to the air exhaust port by the fan. Furthermore, the handle has a grip portion which extends along the axis direction, and a bent portion which extends intersecting the axis direction and connects the grip portion and the connection portion. The bent portion is arranged in a way that the position of the bent portion in the axis direction overlaps with the air exhaust ports.

According to still another characteristic of the present invention, the grip portion has an operation portion which is operated by the worker to switch the drive of the motor by being operated by the worker, and the operation portion has an operation panel which extends along the axis direction. In addition, a terminal portion which is electrically connected to the battery pack is arranged on the connection portion, and a position of the terminal portion in the axis direction is between the fan and the air exhaust ports. Furthermore, a control circuit substrate that controls the drive of the motor is arranged, and the control circuit substrate is arranged inside the handle in a way that a surface direction is along an axis A1 direction. Moreover, an elastic body may be used which is interposed between the housing and the motor to support a back-end side of the motor. In that case, a size of the elastic body in a radial direction is preferably smaller than a diameter of the motor.

According to still another characteristic of the present invention, auxiliary air exhaust ports are arranged in front of the air exhaust ports of the housing, and a part of the airflow discharged from the fan is discharged to the outside of the housing via the auxiliary air exhaust ports. The auxiliary air exhaust ports are preferably formed in a position in the axis direction that overlaps with the motor.

### [Effect]

According to the present invention, in the portable cleaner having the handle, the flow rate of the exhaust air stream can be ensured, sufficient dust collection capacity can be maintained, and the noise caused by the exhaust air stream can be reduced. In addition, the inside of the handle is also utilized as the pathway for air exhaust, and thus even if the diameter of the connection portion on which the battery pack is mounted is not set to be great, sufficient volume of the wind paths can be ensured. Furthermore, because the air exhaust ports exist in the neighborhood of a confluence of the wind paths of the handle and the connection portion, air exhaust efficiency can be improved. In addition, because the terminal portion which is connected to the battery pack is arranged between the fan and the air exhaust ports, the exhaust air stream can flow in the surrounding of the terminal portion which easily generates heat, and temperature rise of the terminal portion can be suppressed.

### BRIEF DESCRIPTION OF THE DRAWINGS

FIG. 1 is a right side view of a cleaner 1 according to an example of the present invention.

FIG. 2 is a longitudinal cross-sectional view of the cleaner 1 according to the example of the present invention.

FIG. 3 is a diagram for illustrating each portion of a housing 2 in FIG. 2.

FIG. 4 is a cross-sectional view taken along an A-A line of FIG. 1.

FIG. 5 is a cross-sectional view taken along a B-B line of FIG. 1.

FIG. 6 is a view of a motor holder 50 alone in FIG. 2, (A) is a perspective view, and (B) is a side view.

FIG. 7 is a cross-sectional perspective view for showing an attachment state of the motor holder 50 to the housing 2.

FIG. 8 is a perspective view of a rubber bush 70.

FIG. 9 is a right side view of a cleaner 1A according to a second example of the present invention.

FIG. 10 is a longitudinal cross-sectional view of the cleaner 1A according to the second example of the present invention.

FIG. 11 is a right side view of a cleaner 1B according to a third example of the present invention.

FIG. 12 is a front view of the cleaner 1B according to the third example of the invention.

FIG. 13 is a longitudinal cross-sectional view of the cleaner 1B according to the third example of the present invention.

FIG. 14 is a cross-sectional view of a part taken along a C-C line in FIG. 11.

FIG. 15 is a cross-sectional view of a part taken along a D-D line in FIG. 11.

FIG. 16 is a cross-sectional view of a part taken along an E-E line in FIG. 11.

### DESCRIPTION OF THE EMBODIMENTS

### Example 1

Hereinafter, examples of the present invention are described based on the drawings. In the following drawings, the same portions are marked with the same signs, and repeated descriptions are omitted. In addition, in the specification, a front-back direction, a left-right direction, and an up-down direction are described as directions shown in the drawings.

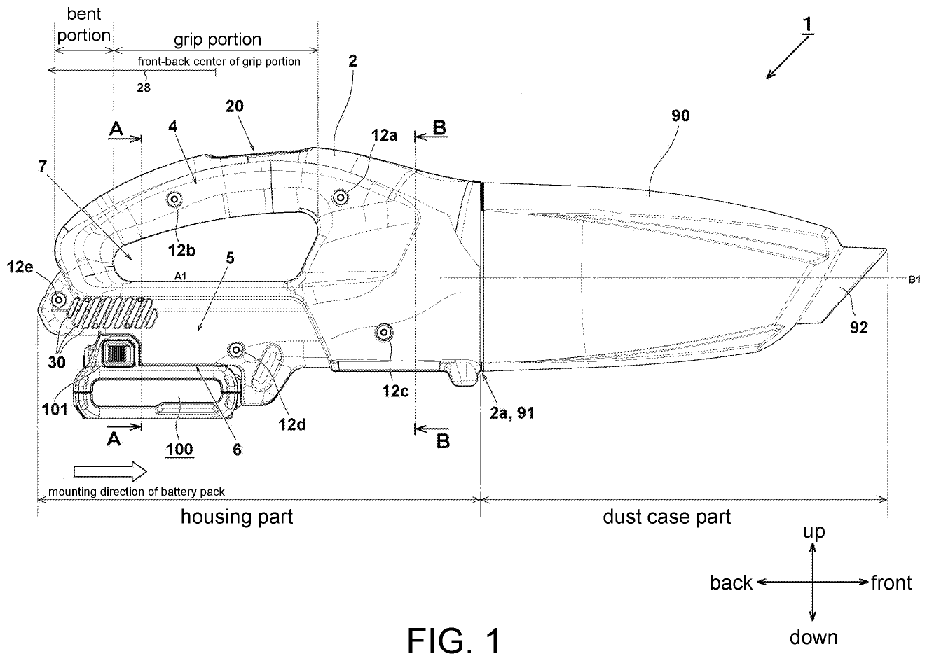

FIG. 1 is a right side view of a portable cleaner 1 according to an example of the present invention. The cleaner 1 is a device which can be gripped by a worker with one hand to perform dust collection work, and the appearance of the cleaner 1 is defined by a main housing 2 and a dust case 90. With respect to the housing 2, a motor and a fan which are described later are accommodated inside the housing 2, and a handle 4 which is gripped by the worker with one hand is formed. In addition, a battery pack 100 is mounted below the handle 4. On a front-side of the housing 2, the cylinder-shaped dust case 90 is mounted. The dust case 90 is configured in a detachable way with respect to the housing 2, a nozzle 92 which is taken as a suction port is formed on a front-side of the dust case 90, and a filter device (not shown) is arranged inside the dust case 90. Here, although not shown, a pipe can be connected to the nozzle 92, and a floor nozzle or the like can be connected to a front-end of the pipe.

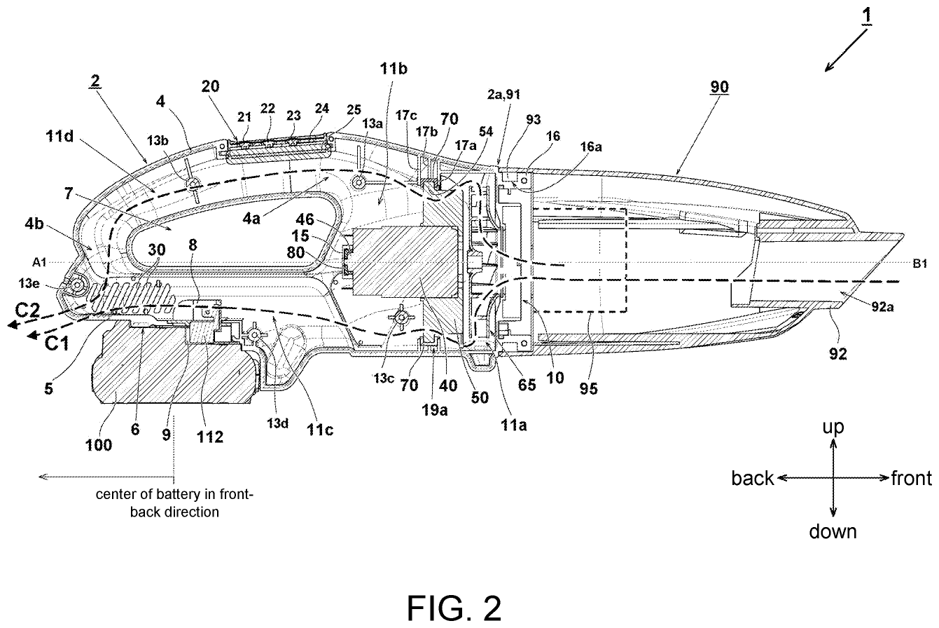

The housing 2 is a synthetic-resin molded product and is configured in a two-part format having a division surface in a vertical direction. Left and right components of the housing 2 have a plurality of screw bosses 12a to 12e with screw holes and screw bosses 13a to 13e with female screws (described later in FIG. 2), and are fixed by fixing elements such as screws or the like (not shown). The dust case 90 is manufactured by integral molding of a synthetic resin and does not have a division surface in the vertical direction. The dust case 90 can be mounted by being aligned with respect to the housing 2, being pushed backward in an axis B1 direction, and then being rotated around the axis B1 by about 120 degrees. The dust case 90 is detached as long as a reverse operation of the attachment operation is performed. Moreover, the fixing structure of the dust case 90 to the housing 2 is arbitrary in the present invention, and another well-known fixing method may be used. The axis B1 is a rotational center during the attachment/detachment of the dust case 90, and in the example, a positional relation is set that an axis A1 of a drive shaft of the motor is coaxial with the axis B1 that is taken as the rotational center during the attachment/detachment of the dust case 90.

A penetration portion 7 for the worker to insert four fingers from the index finger to the little finger is formed on a back-side of the housing 2, and has a substantially D-shape which is rotated by 90 degrees in a side view. With the D-shaped cavity (the penetration portion 7) therebetween, one side is the handle 4 to be gripped by the worker, and the other side is a connection portion 5. The handle 4 has a grip portion which extends along an axis A1 direction, and a bent portion which extends intersecting the axis A1 and connects the grip portion and a back-end of the connection portion 5. The bent portion is arranged in a way that the position of the bent portion viewed in the axis A1 direction overlaps with air exhaust ports 30. On an upper surface of the handle 4, an operation panel portion 20 is arranged which has a switch for turning on or turning off of the motor.

On a side-surface of the housing 2, the air exhaust ports 30 are arranged which are used for discharging air that is filtered by a filter device (described later) in powder-dust-laden air that is sucked in via the nozzle 92. The air exhaust ports 30 are a plurality of slits of which the longitudinal direction is obliquely arranged with respect to the axis B1 (or the axis A1 described later in FIG. 2). In total, nine air exhaust ports 30 are formed in way that the slits having narrow widths extend in parallel directions in order to prevent insertion of a foreign matter to the inside. However, sizes of openings of the air exhaust ports 30 are limited in order to prevent insertion of a foreign matter, and the shapes of the air exhaust ports 30 are arbitrary as long as the shapes do not disturb the exhaust air stream.

A battery mounting portion 6 is arranged on a lower surface of the connection portion 5 of the housing 2, and the battery pack 100 is detachably attached to the battery mounting portion 6. The battery pack 100 accommodates a plurality of battery cells inside a case to supply electric power to a motor 40. The battery pack 100 can be mounted by sliding the battery pack 100 toward the front of the housing 2 in the axis A1 direction, and can be detached by pressing a latch button 101 and sliding the battery pack 100 toward the back in the axis A1 direction.

FIG. 2 is a longitudinal cross-sectional view of the cleaner 1 according to the example of the present invention. The motor 40 is accommodated inside the housing 2, and an output shaft (not shown) of the motor 40 is arranged in a direction along the axis A1. Here, the axis A1 is set to be coaxial with the rotation axis B1 for the attachment of the dust case 90. The output shaft (not shown) of the motor 40 protrudes toward a front-side (a side opposite to the battery mounting portion 6) from the motor 40, and a fan 65 is arranged on a front-end of the output shaft. The connection portion 5 is formed below the penetration portion 7 of the housing 2, and the battery pack 100 is mounted below the connection portion 5. The connection portion 5 has a hollow shape in which an internal space that is continuous from a motor accommodation portion 3 is formed, and the air exhaust ports 30 are formed in the vicinity of the back-end of the connection portion 5. In addition, the neighborhood of the back-end of the connection portion 5 is linked with the neighborhood of a lower-side of a back-end portion 4b of the handle 4. Below the connection portion 5, the battery mounting portion 6 is formed, and the battery pack 100 is mounted.

The motor 40 is a direct-current motor having a rotor accommodated inside a motor case made of metal and is referred to as a so-called “casing motor”. Here, the internal structure of the motor 40 is not shown, but the whole motor 40 is covered by a magnetic material approximately forming a circular cylinder shape, for example, 2 to 3 mm wide iron-material, and the case of the motor 40 also serves as a part of stator. A circular-arc-shaped permanent magnet (not shown) is fixed to an inner peripheral sidewall surface of the case, and a stator yoke (described later in FIG. 7), which is made of magnetic metal and is formed in a way of bending a heavy plate to a circular-arc-shape, is arranged on an outer peripheral surface of the case. The rotor which is fixed to the output shaft (not shown) is built in the motor 40.

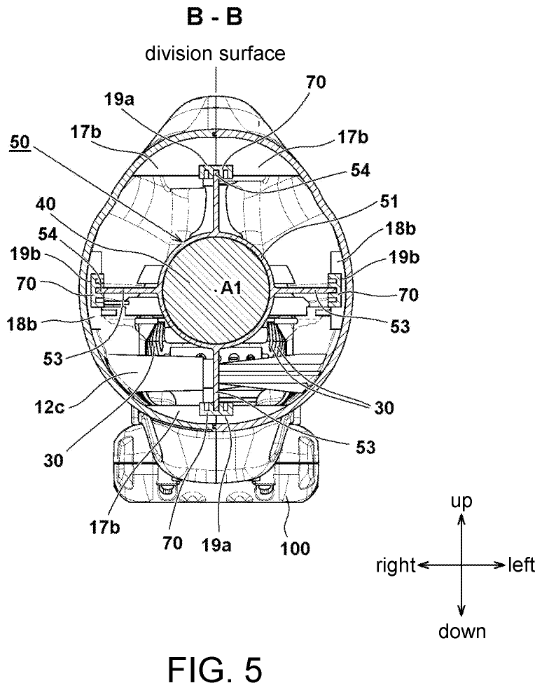

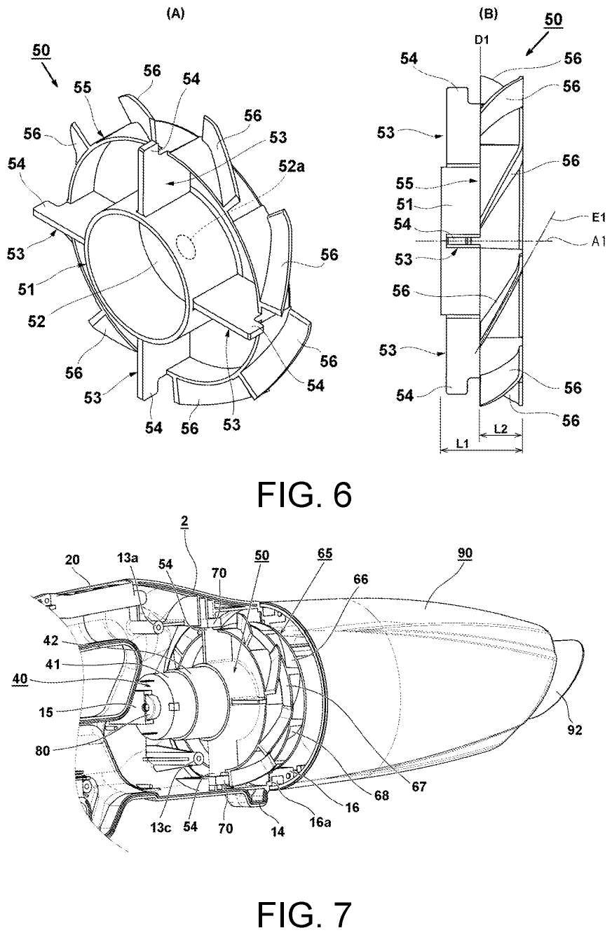

An outer peripheral portion in the neighborhood of a front-end of the motor 40 is held by a motor holder 50 having a circular-cylinder-shaped holding surface (an internal cylinder portion 51 described later in FIG. 6). On an upper-side and a lower-side of the motor holder 50, protrusion portions 54 for the connection to the housing 2 are arranged. The protrusion portions 54 are held by inserted holes 19a which are formed on the housing 2 side via rubber bushes 70. The inserted holes 19a are formed in two locations on an upper-side and a lower-side of the housing 2, and the inserted hole 19a is formed by three ribs 17a to 17c which are formed adjacent to each other in parallel. Moreover, although not shown in the cross-sectional view of FIG. 2, parts that extend in a horizontal direction are formed on a right-side and a left-side of the motor holder 50, the same protrusion portions 54 are also formed on both left and right ends (described later in FIG. 5 and FIG. 6), and the left and right protrusion portions 54 are held by inserted holes 19b (details are described later in FIG. 5) that are formed on the housing 2 side via the rubber bushes 70. A drive portion of the example is configured by the motor 40 having the output shaft, and the motor holder 50 which supports the motor 40 and is supported by the housing 2 by a first elastic member.

In the neighborhood of a back-end of the motor 40, a back-side shaft bearing holding portion 46, which has a shape that protrudes in a circular cylinder shape from a back-end surface of the case, is held by a motor back-end holding portion 15 that is formed inside the housing 2. At this time, because a rubber cap 80 which is taken as a second elastic body is mounted on the back-side shaft bearing holding portion 46, the motor 40 is elastically supported by the motor back-end holding portion 15 via the rubber cap 80. The motor back-end holding portion 15 is formed over both the right-side parts and the left-side parts of the housing 2, and has a positional relation of clamping the back-side shaft bearing holding portion 46 of the motor 40. The rubber cap 80 is manufactured by integral molding of a synthetic rubber, and an internal diameter of the rubber cap 80 has a size at which the rubber cap 80 can be mounted on an outer peripheral surface of the back-side shaft bearing holding portion 46.

The fan 65 is fixed to the output shaft (not shown) of the motor 40 and is rotated around the axis A1 in synchronization with the rotation of the motor 40. The fan 65 is a centrifugal fan, sucks a wind from the front-side along the axis A1, and discharges the wind radially outward from the fan 65. As shown by an arrow C1, the air, which is sucked into the dust case 90 from the nozzle 92, flows from the outside to the inside of a filter device 95, and thereby the foreign matter such as garbage, dust, or the like is captured. The air which reaches the inside of the filter device 95 flows into the internal space of the housing 2 from an air intake port 10, reaches a fan room 11a which is taken as the accommodation space of the fan 65, and is sucked in by the fan 65. The air is discharged radially outward from the vicinity of the axis A1 by the fan 65 in the fan room 11a, flows through an outer peripheral side of an external cylinder portion 55 (see FIG. 6 for the sign) of the motor holder 50 to a back-side, and reaches a motor accommodation room 11b. In FIG. 2, with respect to the flow of a cooling wind, an airflow C1 which mainly flows on a lower-side of the motor 40 and an airflow C2 which mainly flows on an upper-side of the motor 40 are shown by arrows, but the flow is not clearly separated, and the flow shown by the arrows is taken as an example.

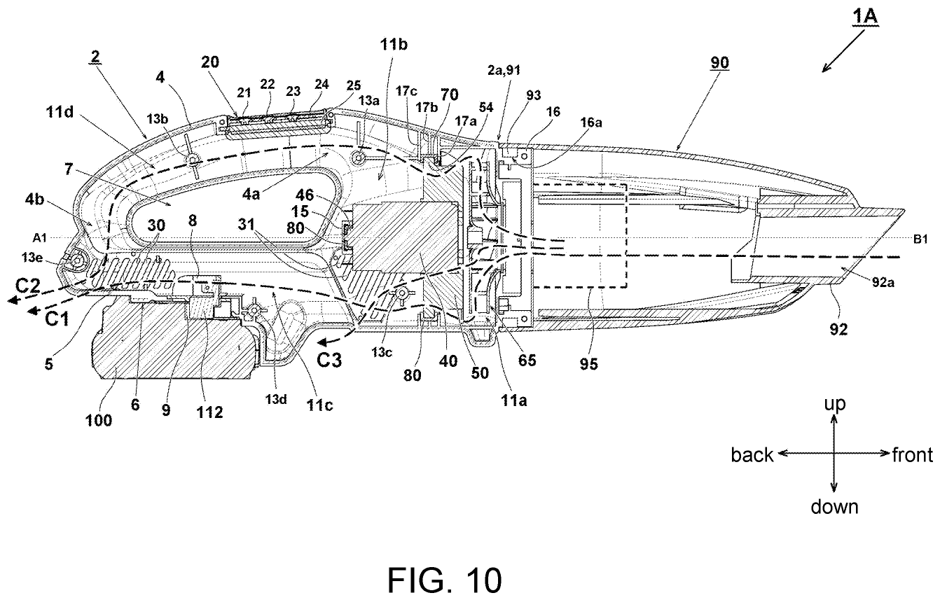

In a conventional cleaner, the flow of the cooling wind is discharged to the outside from air exhaust ports (great air exhaust ports equivalent to auxiliary air exhaust ports 31 in FIG. 10 described later) which are arranged on both left and right sides inside the motor accommodation room 11b. In addition, in an internal space 11d of the handle 4, a mechanical trigger switch mechanism is arranged, and thus the internal space 11d is in a state that the internal space 11d is unavailable as a wind path substantively. Furthermore, in the neighborhood of a connection room 11c which is an internal space of the connection portion 5, main-body-side terminals 9 engagement with a connection terminal 112 of the battery pack 100 are arranged, and wiring (not shown) and a control circuit substrate for the motor 40 are further arranged. Thus, the connection room 11c is in a state that the connection room 11c is unsuitable for the use as a wind path. However, in the example, the air exhaust ports 30 are arranged on a back-side, and not only the connection room 11c is used as a wind path (a first flow path), but also the internal space 11d of the handle 4 is used as a wind path (a second flow path).

In the cleaner 1, if a “strong mode” button 21 or a “weak mode” button 22 of the operation panel portion 20 is pressed, electric power of the battery pack 100 is supplied to the motor 40, and the motor 40 is rotated. If an “off” button 23 is pressed during the rotation of the motor 40, the electric power of the battery pack 100 is no longer supplied to the motor 40, and the motor 40 stops. An indicator lamp 24 is arranged adjacent to these three buttons 21 to 23. The indicator lamp 24 turns on during the rotation of the motor 40 and turns off if the “off” switch is pressed and the motor 40 stops.

Because the fan 65 is rotated when the motor 40 is rotated, the air inside the dust case 90 is sucked out, and thereby pressure inside the dust case 90 becomes negative and a sucking force is generated in an air exhaust path 92a. Therefore, air and foreign matters outside the housing 2 are sucked from the suck-in nozzle 92 into the dust case 90. In the example, the fan 65 is rotated, and thereby the airflows C1 and C2 flow. Arrangement of the wind paths of the example has the following characteristics. (1) The main airflow C1 is discharged to the outside via the air exhaust ports 30 which are arranged in the vicinity of the back-end of the housing 2. Therefore, a control circuit substrate 25, which is conventionally accommodated inside the connection room 11c that is the wind path of the airflow C1, is moved directly below the operation panel portion 20. In addition, a size of a terminal holder 8 inside the connection room 11c is reduced to make the air inside the connection room 11c flow smoothly. (2) As the wind path from the motor accommodation room 11b to the air exhaust ports 30, the inner-side space of the handle 4 (the handle space 11d) is used to allow the air to flow as C2. In order to effectively utilize the handle space 11d as the wind path, the thickness of the operation panel portion 20 is reduced by using, as the turn-on/turn-off switches of the motor 40, soft-touch switches (21 to 23) instead of mechanical switches having trigger levers. Furthermore, the control circuit substrate 25 is accommodated in the operation panel portion 20, and the size of the operation panel portion 20 is compactly configured. As can be understood from FIG. 2, a sufficient space can be ensured as the wind path below the operation panel portion 20. (3) The airflows C1 and C2 are confluent on a back-end of the handle 4, and the air exhaust ports 30 are arranged in the neighborhood of the confluence to exhaust the air efficiently. (4) Because the airflow C2 flows inside the handle 4, cooling effects on the operation panel portion 20 and the control circuit substrate 25 are improved.

As described above, in the example, because not only a shortest pathway (the inner-side of the connection portion 5) from the back of the motor 40 to the air exhaust ports 30 is used as the wind path of a flow as the airflow C1, but also the internal space of the handle 4 is used as the wind path of the airflow C2 which has been sucked in, the wind paths of the cooling wind can be sufficiently ensured even in the cleaner 1 in which the battery pack 100 is mounted below the connection portion 5. Thus, the size of the connection portion 5 is not required to be enlarged. In addition, because outlet ports of the air exhaust are approximately on the back-end of the housing 2, the noise caused by the rotation of the fan 65 can be greatly reduced.

On an inner-side of an opening portion 2a on the front-side of the housing 2, a circular cylinder portion 16 which constitutes an attachment mechanism that attaches the dust case 90 is formed. The circular cylinder portion 16 is formed on the housing 2 side, and the groove portion 16a is formed which extends in the axis direction and a circumferential direction and has an L-shape viewed from the outside in the radial direction. Meanwhile, a convex portion 93 is formed on an inner-side of an opening portion 91 of the dust case 90, and after the convex portion 93 is moved in the axis direction, the inside of the groove portion 16a is rotated by about 120 degrees in the circumferential direction and is held in an engagement position. In addition, the convex portion 93 can be extracted from the groove portion 16a by rotating the dust case 90 centered on the axis B1 with respect to the housing 2. If the convex portion 93 is extracted from the groove portion 16a, the dust case 90 can be detached from the housing 2.

The filter device 95 is arranged on an inner-side of the circular cylinder portion 16. The filter device 95 includes a prefilter and a filter medium (not shown), has a cup-like shape which is configured so as to have air permeability, and is configured in a way that an opening portion of the cup faces the opening portion 2a side of the housing 2. Moreover, the shape of the dust case 90 including the filter device 95 is arbitrary and is not limited to the shape described in the example. In addition, a cyclone dust collection type may be used.

The dust case 90 is a member which is obtained by integrally molding the synthetic resin to a cylinder shape. The dust case 90 has a circular cylinder shape along the axis B1 which is the rotational center for the attachment to the housing 2. The dust case 90 includes the suck-in nozzle 92 on the front-side, and the opening portion 91 that is connected to the opening portion 2a of the housing 2 is formed on the back-side. The dust case 90 is attached to the housing 2 in a way of covering an outer-side of the circular cylinder portion 16 of the housing 2. The suck-in nozzle 92 of the dust case 90 is arranged on a side opposite to the opening portion 91 in the direction along the axis B1. Here, the axis A1 of the motor 40 and the axis B1 of the dust case 90 are configured to be consistent, but the axes A1 and B1 are not required to be consistent, and the axes A1 and B1 may be arranged offset or obliquely facing each other. The suck-in nozzle 92 is a cylinder body which is arranged concentrically with the axis B1, and the suck-in nozzle 92 forms the air exhaust path 92a. The air exhaust path 92a is a pipeline which connects the inside and the outside of the dust case 90 and is a connection portion for connecting an extension pipe (not shown).

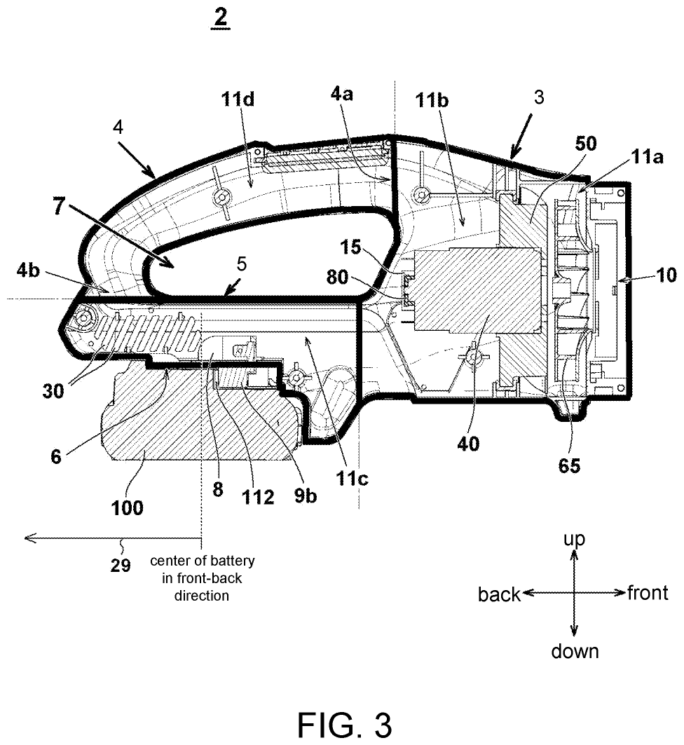

FIG. 3 is a diagram for describing each portion of the housing 2. The inside of the housing 2 can be defined to three main spaces which are partitioned by ranges shown by heavy lines. One space is the motor accommodation portion 3 which accommodates the motor 40 and the fan 65. Here, in order to arrange the motor 40 having a small diameter approximately in the neighborhood of an axial center of the housing 2 having a circular cylinder shape, a front-side of the motor 40 is held by the motor holder 50, and a back-side of the motor 40 is held by the motor back-end holding portion 15 which is formed in an inner-wall part of the housing 2. That is, the motor holder 50 is also an attachment member for holding, in a position consistent with the axes A1 and B1, the motor 40 which is sufficiently small compared with the internal diameter of the housing 2. A part of the motor 40 is arranged inside the motor holder 50 in the direction along the axis A1. Screw holes (not shown) are formed on a front sidewall surface of the motor 40, and the motor 40 is fixed to the motor holder 50 by a plurality of screws (not shown) using screw holes which are formed in a bottom surface portion 52 (see FIG. 6 for the sign) of the motor holder 50. A great space (the motor accommodation room 11b) is formed between an outer peripheral surface of the motor 40 and an inner-wall surface of the housing 2, and the motor holder 50 is configured in a way of not hindering the wind paths.

The handle 4 is a circular-cylinder-shaped space of which the inside is hollow, and a front-end portion 4a is linked with the motor accommodation portion 3, and thereby the internal space (the handle space 11d) which is continuous from the motor accommodation portion 3 is formed. The back-end portion 4b of the handle 4 is linked with the connection portion 5. The internal space of the handle 4 (the handle space 11d) and the internal space of the connection portion 5 (the connection room 11c) are spatially connected. Viewed in an axis direction of the housing 2, the air intake port 10 is arranged in front of the fan 65, and the air exhaust ports 30 are arranged behind the motor 40. The connection portion 5 is formed to connect the battery pack 100, but in the example, the air exhaust ports 30 are formed in the neighborhood of the back of the connection portion 5. On an outer-side of the battery mounting portion 6, the connection terminal 112 for connection is arranged. If the battery pack 100 is attached to the battery mounting portion 6, the connection terminal 112 comes into contact with the main-body-side terminals 9 which are arranged on the housing 2 side, and thereby electric power is supplied to the motor 40. The motor 40 is formed with an external diameter smaller than the external diameter of the fan 65, and the motor holder 50 is formed with a greatest external diameter greater than the external diameter of the fan 65.

The air exhaust ports 30 are arranged behind the center position of the battery pack 100 in the front-back direction as shown by an arrow 29. According to the configuration, the air exhaust ports 30 are located behind the terminal holder 8, and thus slits which form the air exhaust ports 30 can be obliquely formed in the up-down direction. In addition, viewed in the relation between the air exhaust ports 30 and the grip portion, as shown by an arrow 28, the air exhaust ports 30 are located behind the center position of the grip portion in the front-back direction and are located in a position which overlap with the bent portion in the axis A1.

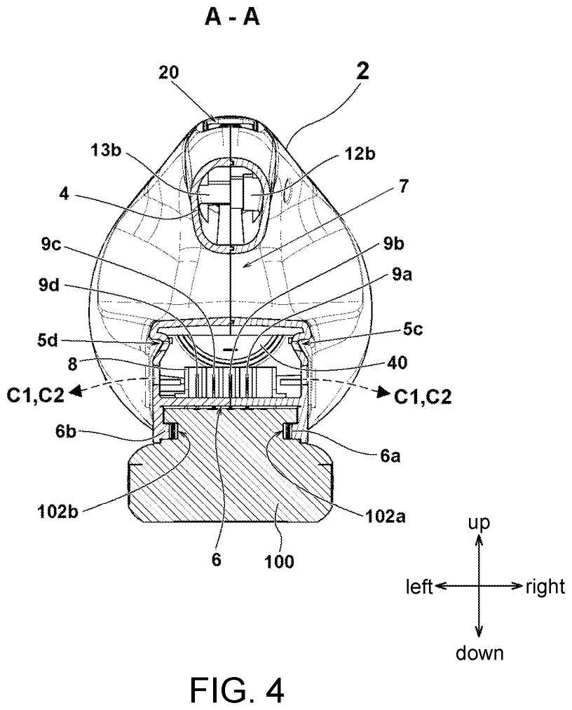

FIG. 4 is a cross-sectional view taken along an A-A line of FIG. 1. The handle 4 and the connection portion 5 at the back of the housing 2 have sufficiently small shapes compared with the motor accommodation portion 3 (see FIG. 3). The battery mounting portion 6 is formed on a lower-side of the penetration portion 7 below the housing 2. An upper-surface of the battery mounting portion 6 is formed as a surface which is approximately horizontal in the left-right direction and the front-back direction. The terminal holder 8 is arranged in the neighborhood of a bottom surface of the battery mounting portion 6, and main-body-side terminals 9a to 9d which extend downward are formed in the terminal holder 8. As seen in FIG. 4 which is obtained by observing the front from a cross-sectional surface of a part taken along the A-A line, the inside of the connection portion 5 is hollow and is in a state in which a back-wall surface of the motor 40 is visible. A rail mechanism for mounting the battery pack 100 is formed below the connection portion 5, and rails 6a and 6b which are formed on the housing 2 side are engaged with rail grooves 102a and 102b of the battery pack 100. In both left and right side-surfaces of the connection portion 5, recessed portions 5c and 5d which are continuous in the axis direction and are obliquely recessed inward are formed in the neighborhood of an upper part. The recessed portions 5c and 5d are used for achieving wind guidance effects for making it difficult for the air discharged from the air exhaust ports 30 to touch the hand of the worker who grips the handle 4.

FIG. 5 is a cross-sectional view taken along a B-B line of FIG. 1. The motor 40 which is accommodated in the circular-cylinder-shaped metal case is sufficiently small compared with the size of the inner-wall of the housing 2. Therefore, the motor 40 is accommodated in the internal cylinder portion 51 of the motor holder 50, plate-like support plates 53 are formed which extend upward, downward, rightward, and leftward from the internal cylinder portion 51, and the motor 40 is fixed to the housing 2 by engaging front-end portions formed in a convex shape (the protrusion portions 54) of respective support plates 53 with the rubber bush 70. That is, four support plates 53 extend at equal intervals in the radial direction from the internal cylinder portion 51 which accommodates the outer peripheral surface of the motor 40, and the protrusion portion 54 (also see FIG. 6 for the sign) is arranged on a front-end part on an outer peripheral side of each of the support plates 53. The rubber bushes 70 are respectively arranged in a way of being located further outward in the radial direction than a front-end of the protrusion portion 54. The rubber bushes 70 which are located on both left and right sides are arranged inside the inserted holes 19b which are formed by ribs 18b that are formed in an inner-wall side of the housing 2. The rubber bushes 70 which are located in the up-down direction are arranged inside the inserted holes 19a which are formed by the ribs 17b that are formed on the inner-wall of the housing 2. Moreover, the ribs 17b are respectively formed in parts which are divided in a vertical surface in the left-right direction.

With regard to the rubber bushes 70, a shape of a cross-section along the circumferential directional which passes through a central point is a shape close to an E-shape, and the rubber bushes 70 are arranged in a way that open parts face the axis A1. In this way, the motor holder 50 is not in contact with the inner-wall surface of the housing 2, and thus no matter which direction the motor holder 50 moves to in the radial direction, the motor holder 50 is elastically held by one to three of the four rubber bushes 70. In addition, due to the characteristic shapes of the rubber bushes 70, a vibration caused by the rotation of the motor 40 in the circumferential direction is formed in a way that an elastic force in the radial direction is weak compared with that in the circumferential direction.

FIG. 6 is a view of the motor holder 50 alone, (A) is a perspective view and (B) is a side view. The basic skeleton of the motor holder 50 is configured by the internal cylinder portion 51 having a circular cylinder shape, the external cylinder portion 55 having a circular cylinder shape, and the support plates 53 which connect the internal cylinder portion 51 and the external cylinder portion 55. The internal cylinder portion 51 acts as a holding portion for holding the neighborhood of the front-end of the motor 40, and the bottom surface portion 52 which is closed is formed on a front-side of the internal cylinder portion 51. In the center of the bottom surface portion 52, a penetration hole 52a for the output shaft of the motor 40 to penetrate through is formed. The internal diameter of the penetration hole 52a is smaller than the internal diameter of the internal cylinder portion 51. The internal cylinder portion 51 and the external cylinder portion 55 are coaxially arranged along the axis A1, and the external cylinder portion 55 is arranged on an outer-side of the internal cylinder portion 51 in the radial direction centering on the axis A1. The internal cylinder portion 51 and the external cylinder portion 55 are linked by the four plate-like support plates 53 which extend in the radial direction. The support plates 53 are linked to four locations which are separated by 90 degrees in the circumferential direction along the axis A1 on an outer peripheral surface of the internal cylinder portion 51. Here, a length L1 of the internal cylinder portion 51 in the axis A1 direction and a length L2 of the external cylinder portion 55 have a relation of L1>L2, and front-end sides of the internal cylinder portion 51 and the external cylinder portion 55 are arranged in a consistent way. The internal diameter of the internal cylinder portion 51 is greater than the external diameter of the motor 40. Lengths of the support plates 53 viewed in the axis A1 direction are approximately the same as the length L1 of the internal cylinder portion 51, and the protrusion portions 54 which are used for the fixing to the housing 2 are formed on radially outer side end portions of the support plates 53 on a back-side that are not consistent with the external cylinder portion 55.

On an outer peripheral portion of the motor holder 50, a plurality of ribs 56 are formed. A central line E1 in a thickness direction of the rib 56 is set to have a positional relation of being inclined with respect to the axis A1 and a perpendicular surface D1. Therefore, the direction of the flow in the circumferential direction which is formed by the rotation of the fan 65 can be guided to a specific direction by the inclination of the plurality of ribs 56, and the flow of the air can be smoothly formed. In the radial direction centering on the axis A1, the protrusion portions 54 are arranged on an inner-side of outer ends of the plurality of ribs 56. Thus, because the protrusion portions 54 does not have to be arranged on an outer-side of the plurality of ribs 56 in the radial direction centering on the axis A1, the size in the radial direction of the housing 2 can be suppressed from being greater. The central line E1 in the thickness direction of the rib 56 of the motor holder 50 extends in a way of being inclined with respect to the axis A1 and being inclined with respect to the perpendicular surface D1 that is perpendicular to the axis A1. The plurality of ribs 56 are parallel to each other.

Behind the ribs 56 (on the motor 40 side), the protrusion portions 54 are arranged on a radially outer side of the support plates 53. The protrusion portions 54 are convex portions which are formed protruding radially outward from the motor holder 50, have plate-like shapes which are long in the axis direction and are thin in the circumferential direction, and are manufactured by integral molding of the synthetic resin along with other parts of the motor holder 50. As seen in the diagram, the external diameter of a circumscribed circle of the plurality of ribs 56 is set to be greater than the external diameter of a circumscribed circle of the plurality of protrusion portions 54. In addition, the plurality of protrusion portions 54 are arranged on the inner-side of the outer ends of the ribs 56 in the radial direction centering on the axis A1. Here, the motor 40 and the motor holder 50 constitute the drive portion, and the drive portion is held on the inner-side of the housing 2. In the present invention, the inserted holes 19a and 19b in which first elastic portions (the rubber bushes 70) are fitted may be formed on one side of the housing 2 or the drive portion, and convex portions may be configured on the other side, but in the example, convex portions (the protrusion portions 54) are formed on the drive portion side and the inserted holes are formed on the housing 2 side.

With regard to the motor holder 50, viewed in the direction along the axis A1, a position which is occupied by the fan 65 in the axis direction does not overlap with a position which is occupied by the protrusion portions 54 in the axis direction. Therefore, because the protrusion portions 54 does not have to be arranged on an outer-side of the fan 65 in the radial direction on the basis of the axis A1, the internal diameter of the housing 2 can be suppressed from being greater, and additionally, a space in which the rubber bushes 70 are arranged can be easily ensured. In addition, the flow of the air from the space on the fan 65 side (the fan room 11a) to the motor accommodation room 11b (see FIG. 3) can be straightened by the plurality of ribs 56 which are arranged in the motor holder 50. Because the plurality of ribs 56 act as flow straightening plates, dust collection efficiency in the filter device 95 is improved.

The housing 2 is configured in a way of being divided to two parts of the right-side part and the left-side part, and the motor holder 50 is clamped and fixed between the right-side part and the left-side part. In addition, an arrangement range of the protrusion portions 54 and an arrangement range of the motor 40 are set to have a positional relation of overlapping with each other in the direction along the axis A1. Thus, the gravity center of the motor 40 and the protrusion portions 54 can be brought as close as possible in the direction along the axis A1, the motor 40 can be stably held, and vibration suppression also has an effective action. In addition, the rubber bushes 70 which are formed by rubber-like elastic bodies are interposed between the protrusion portions 54 and the inserted holes 19a and 19b, and shapes of the rubber bushes 70 are set to be characteristic (described later). Furthermore, the rubber cap (a second elastic member) 80 which is formed by a rubber-like elastic body is interposed between the motor back-end holding portion 15 and the back-side shaft bearing holding portion 46. Thus, the vibration of the motor 40 can be suppressed from being transmitted to the housing 2.

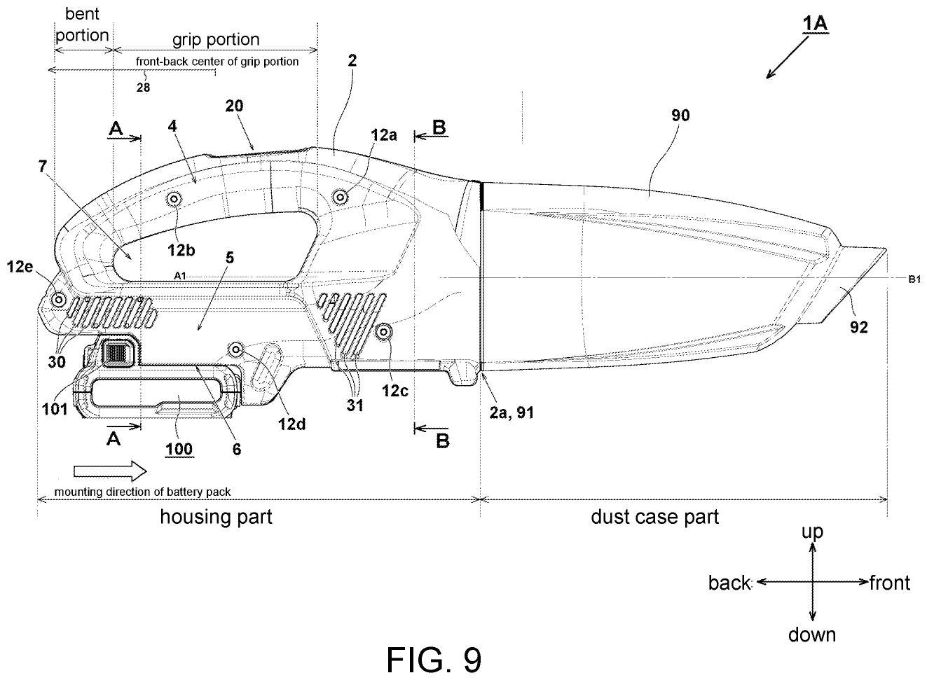

FIG. 7 is a cross-sectional perspective view for showing an attachment state of the motor holder 50 to the housing 2. Here, the state is equivalent to a state in which the right-side part of the housing 2 is detached. The motor 40 is accommodated in a metal case 41 having a circular cylinder shape, and a stator yoke 42 which is obtained by winding a slightly thick metal plate is attached on an outer peripheral side of the metal case 41. The internal cylinder portion 51 of the motor holder 50 satisfactorily abuts against an outer peripheral surface of the stator yoke 42, and thereby an assembled body (the drive portion) including the motor 40 and the motor holder 50 is configured. In FIG. 9, two rubber bushes 70 which hold the motor holder 50 are arranged. The rubber bush 70 on the right-side shows a state of not being attached to the motor holder 50. The fan 65 is a centrifugal fan, a circular ring plate 66 is arranged on a front-side in the axis A1 direction, a circular plate 67 is arranged parallel to the circular ring plate 66 on a back-side in the axis A1 direction, and a plurality of blades 68 are formed between the circular ring plate 66 and the circular plate 67. The blades 68 are shaped to spirally curve and extend to an outer edge position of the circular ring plate 66 from a position that is separated radially outward from the axis A1 by a predetermined distance, and the blades 68 discharge the air radially outward from a side close to the axis A1.

The back-side of the motor 40 is fixed to the motor back-end holding portion 15 via the rubber cap (the second elastic portion) 80 which covers the surrounding of the back-side shaft bearing holding portion 46 (see FIG. 2) that holds the output shaft. The motor back-end holding portion 15 is a beam member which extends radially inward toward the division surface from a side-surface of the housing 2 on the left-side. Although not shown in the diagram, a same beam member is also formed extending from a side-surface of the housing 2 on the right-side, and the rubber cap 80 is clamped by the contact of two beam members (the motor back-end holding portion 15). In the rubber cap 80, a penetration hole is formed in a bottom surface of a rubber member of a container. The penetration hole is formed in order to avoid the contact with the output shaft of the motor 40, and the penetration hole, a recessed hole, or the like is not required to be formed if the output shaft is not exposed to the outside from the metal case 41.

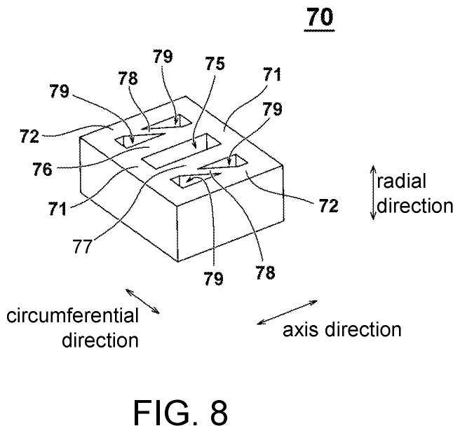

FIG. 8 is a perspective view of the rubber bush 70. The rubber bush 70 which is taken as the first elastic portion is interposed between the housing 2 and the drive portion in the circumferential direction and a radial direction of the axis A1, and the drive portion is formed in a way of being displaced more easily in the circumferential direction than in the axis direction. Therefore, the size of the rubber bush 70 in the circumferential direction is greater than the size in the axis direction. The rubber bush 70 is arranged in at least one of the housing 2 and the drive portion, has an inserted hole (inserted hole 75) into which the convex portion formed in the drive portion is inserted, and is formed in a way that the convex portion (the protrusion portion 54) is displaced more easily in the circumferential direction than in the axis direction. That is, the spring constant of the rubber bush 70 in the circumferential direction is formed smaller than the spring constant in the axis direction. Inserted hole holding walls 76 and 77 are formed between short-side sidewall portions 72 and the inserted hole 75. Link ribs 78 are arranged in a way of obliquely linking the short-side sidewall portion 72 and the inserted hole holding wall 76 and obliquely linking the short-side sidewall portion 72 and the inserted hole holding wall 77. As shown by the radial direction, the axis direction, and the circumferential direction in the diagram, the rubber bush 70 is configured in a way that the length in the circumferential direction is the longest, and the convex portion (the protrusion portion 54) is formed in a way of being displaced more easily in the circumferential direction than in the axis direction.

In the circumferential direction of the rubber bush 70, elastic regions are formed by arranging the hollow portions 79 which are adjacent to the inserted hole and arranging cavities in the circumferential direction of the elastic body. The hollow portion 79 may be set to have the same shape as the inserted hole 75 viewed in the radial direction. However, if the hollow portion 79 is set to have the same shape, erroneous mounting, in which the protrusion portion 54 is erroneously inserted to the hollow portion 79 instead of the inserted hole 75, may occur in manufacture and assembly process. Therefore, a hindering wall (the link rib 78) is formed so as to divide the hollow portion 79. Long-side sidewall portions 71 are arranged on outer-sides of the rubber bush 70 in the axis direction, and the short-side sidewall portions 72 are arranged on outer-sides in the circumferential direction. By changing thicknesses and angles of the link ribs 78, the elastic deformation amount of the rubber bush 70 to the circumferential direction becomes easy to adjust.

The rubber bush 70 is integrally manufactured by die molding using the synthetic rubber, and in a part having outer edges which are substantially cuboid, four hollow portions 79, which are formed adjacent to the inserted hole 75 and are used for reducing buffer force of the rubber in a specific direction, are molded integrally with the inserted hole 75 of the protrusion portion 54. The rubber bush 70 has a characteristic of reducing the transmission of the vibration which is generated from the motor 40 to the housing 2 via the motor holder 50, and conversely suppressing transmission of a vibration from the housing 2 side to the motor 40. For this object, the natural frequency of a vibration system to be supported by vibration absorption is considered, and the material and the shape are set to be the most suitable. In the example, in order to relieve a sudden change of inertial force to the rotation direction of the motor 40, particularly along with rotation force of the motor 40, a buffer force of the movement to the circumferential direction of the protrusion portions 54 of the motor holder 50 is increased. That is, by forming the hollow portions 79, deformation of the rubber bush 70 to the circumferential direction can be made easy, and great impact energy can be absorbed. In addition, an effect of early attenuating a vibration after the impact of the rubber bush 70 to circumferential direction is enhanced.

### Example 2

Next, a cleaner 1A according to a second example of the present invention is described using FIG. 9 and FIG. 10. FIG. 9 is a right side view of the cleaner 1A. Here, the auxiliary air exhaust ports 31 are arranged in addition to the main air exhaust ports 30 for discharging the air filtered by the filter device, which is different from that in the cleaner 1 shown in FIG. 1. The auxiliary air exhaust ports 31 are respectively arranged in a right-side side-surface and a left-side side-surface of the housing 2.

FIG. 10 is a longitudinal cross-sectional view of the cleaner 1A. Expect that the auxiliary air exhaust ports 31 are newly arranged, other configurations of a housing 2A are exactly the same as the housing 2 of the first example. The auxiliary air exhaust ports 31 are formed in the middle of the wind path from the fan 65 to the main air exhaust ports 30. The shapes of the auxiliary air exhaust ports 31 are the same as those of the main air exhaust ports 30, and are formed by a plurality of slits of which the longitudinal direction is obliquely arranged with respect to the axis A1, and the longitudinal direction of the slits is formed toward the same direction as that of the main air exhaust ports 30. As shown in FIG. 10, due to the airflows C1 and C2, when only the main air exhaust ports 30 are used, an air exhaust resistance may be increased. Problems are caused particularly in a case of improving the output of the motor 40. Therefore, in the second example, the air, which is not discharged due to the lack of the opening area of the air exhaust ports, is discharged to the outside as an airflow C3 using the auxiliary air exhaust ports 31 which are arranged in the vicinity of the motor 40. The auxiliary air exhaust ports 31 are arranged in a way of partially overlapping with the motor 40 viewed in the axis A1 direction of the motor 40, and particularly, a lower-side part at the back of the motor 40 overlaps with the auxiliary air exhaust ports 31 in the axis A1 direction. Here, the auxiliary air exhaust ports are not arranged on an upper-side part at the back of the motor 40. By arranging the auxiliary air exhaust ports 31 in the vicinity of the motor 40 of the housing 2 in this way, increase in the sucked-in wind along with the improvement of the output of the motor 40 can be discharged to the outside by the auxiliary air exhaust ports 31, and thus the rotation load of the fan 65 and the motor 40 can be reduced, and the increase in the noise along with the improvement of the output of the motor 40 can be suppressed. In addition, because air exhaust efficiency can be improved, the increase in electric-power consumption along with the improvement of the output of the motor 40 can be suppressed, and the reduction in the working time of the battery pack can be suppressed.

### Example 3

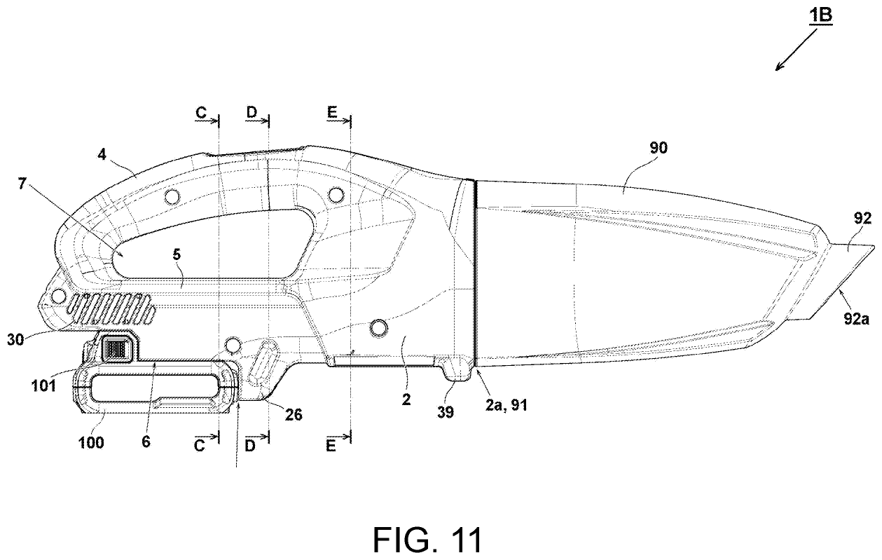

Next, a cleaner 1B according to a third example of the present invention is described using FIG. 11 to FIG. 16. FIG. 11 is a right side view of the cleaner 1B. The cleaner 1B is exactly the same as the cleaner 1 shown in FIG. 1 in appearance. Positions and shapes of the main air exhaust ports 30 for discharging the air filtered by the filter device to the outside are also the same. The connection portion 5 having a shape of being narrowed-down in the up-down direction is arranged below and behind the motor 40 in the housing 2 of the cleaner 1B, and the battery 100 is mounted below the narrowed-down part. A battery guard 26, which protrudes radially downward from the axis A1 so as to cover a front surface wall of the battery pack 100, is formed on a front-side of the battery mounting portion 6 of the housing 2. The battery guard 26 is a part which is formed in a way of protruding downward, performs guard so as not to bump into an object from the front in a state in which the battery pack 100 is attached, and protects the main-body-side terminals 9 (not shown) from contacting with a floor surface or the like when the battery pack 100 is detached. The battery guard 26 is molded integrally with the housing 2 which is formed in the left-right division type, and has a division surface in the center in the left-right direction. In addition, in the neighborhood of a lower-side of the opening portion 2a on a front-side of the housing 2, a leg portion 39 is formed which protrudes downward from a substantially circular-cylinder-shaped part of the housing 2. The leg portion 39 is molded integrally with the housing 2 and has a division surface in the center in the left-right direction. By forming the leg portion 39, in a state in which the cleaner 1B is placed on a table or the like, the opening portion 2a of the housing 2 and the opening portion 91 of the dust case 90 are slightly above the floor, and thus the dust case 90 can be easily rotated even in the placement state of the cleaner 1B.

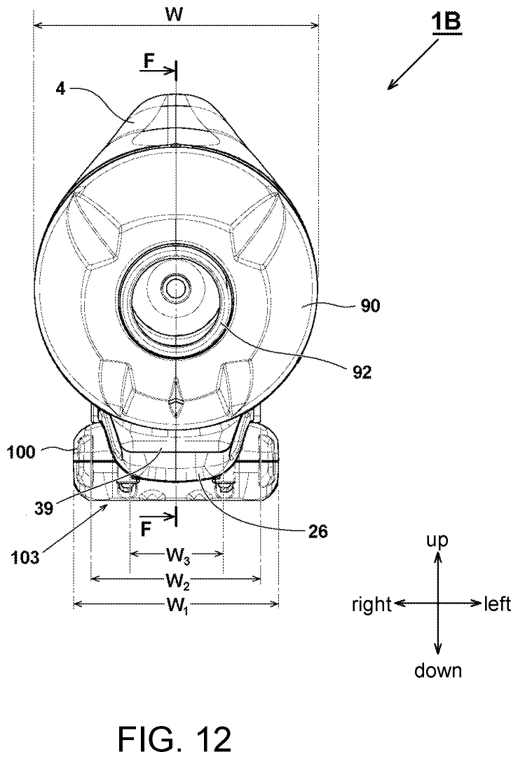

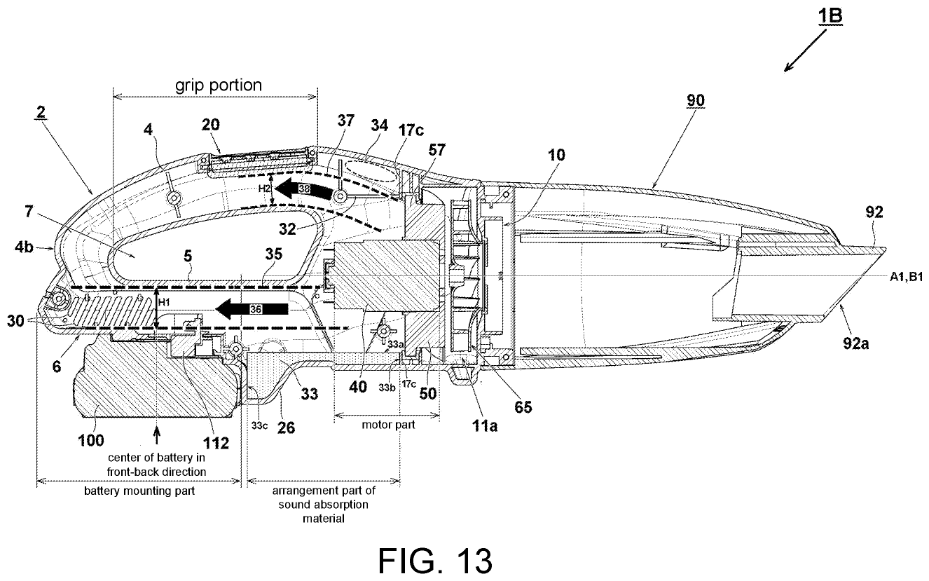

FIG. 12 is a front view of the cleaner 1B according to the third example of the invention. If the cleaner 1B is viewed from the front, sizes of the battery guard 26 and the leg portion 39 viewed from the front, particularly the size of the battery pack 100 viewed from the front can be compared with the size of the dust case 90. A bottom surface 103 of the battery pack 100 is flat, and if the cleaner 1B is placed on the floor or the like in a state in which the battery pack 100 is mounted, the bottom surface 103 of the battery pack 100 and the leg portion 39 abut against the floor or the like. A width W₂ of the battery mounting portion 6 in the left-right direction is formed smaller than a width W of the dust case 90 and the housing 2 in the left-right direction. A width W₁ of the battery pack 100 in the left-right direction is smaller than the width W of the housing 90 and is greater than the width W₂ of the battery mounting portion 6. Widths W₃ of bottom surfaces of the battery guard 26 and the leg portion 39 in the left-right direction are approximately equal, but the battery guard 26 protrudes downward more compared with the leg portion 39, and additionally, the bottom surface of the battery guard 26 is formed in a gentle circular-arc-shape. In this way, the battery guard 26 is configured to have a certain size, and thus a predetermined space exists inside the battery guard 26, and the space of the battery guard 26 is a dead space which is not used as an airflow path. In the third example, the internal space of the battery guard 26 is used as a part of a space in which a sound absorption material 33 described later in FIG. 13 is arranged.

FIG. 13 is a longitudinal cross-sectional view showing the whole configuration of the cleaner 1B and is a cross-sectional view of a part taken along an F-F line of FIG. 12. The sound absorption material 33 which extends forward from an inner-side of the battery guard 26 is arranged inside the housing 2, which is different from the first example. The sound absorption material 33 is a porous material such as soft urethane foam or the like. If a sound touches the porous material, air vibration is transmitted to air of a bubble part which exists inside the sound absorption material 33, viscous friction of the air is generated on a bubble surface, and a part of energy of the sound is transformed into thermal energy, and thus a sound absorption action is generated. In this way, the sound absorption material attenuates the vibration of air and reduces the sound by a resistance with respect to air movement, and thus by arranging the sound absorption material 33 in the middle of the pathway from the fan 65 to the air exhaust ports 30, sound leaking to the outside from the air exhaust ports 30 can be reduced.

Inside the housing 2, a wide space which has a great diameter and accommodates the motor 40 and the fan 65, a narrow internal space having a small diameter of the handle 4, and an internal space of the connection portion 5 which is narrow in the up-down direction are arranged, and in the example, the sound absorption material 33 is arranged inside the wide space. The sound absorption material 33 is arranged below the motor 40, and a front-end surface 33b of the sound absorption material 33 is in contact with a back surface of the rib 17c. Viewed in the axis A1 direction, a back-end 33c of the sound absorption material 33 extends backward from a back-end side of the motor 40 and reaches an inner back-end wall of the battery guard 26. The sound absorption material 33 is three-dimensionally molded in a way of corresponding to the internal shape of the housing 2, and is configured in a way of not generating a gap as much as possible between the wall surface and the sound absorption material 33 on a surface which is in contact with the wall surface of the housing 2. However, the shape of the sound absorption material is not limited to a three-dimensional shape. For example, a flat and plate-like sound absorption material may be used, and the sound absorption material may be deformed and crammed inside the housing 2, and thereby no gap may be generated between the housing 2 and the wall surface. The fixing method of the sound absorption material 33 is arbitrary, and the sound absorption material 33 is fixed by being clamped by the right-side part and the left-side part of the housing 2 which is formed in a way of being divided in the left-right direction. Moreover, the sound absorption material 33 may be fixed to the housing 2 not only by clamping the sound absorption material 33, but also by using a bonding agent or a double-sided tape to fix a part of the sound absorption material 33 to an inner-wall portion of the housing 2. Furthermore, one or more ribs may be arranged which extend from a right-side inner-wall surface and a left-side inner-wall surface of the housing 2 to a division surface side, and the rib may be located on an upper-side edge portion of the sound absorption material 33 to limit the movement of the sound absorption material 33 to an upper-side.

After flowing into the housing 2 from the internal space of the dust case 90, the airflow generated by the fan 65 passes through the fan 65 and flows through the outer peripheral portion of the motor holder 50 to a back-side in the axis A1 direction, and the majority of the airflow flows through the connection portion 5 as shown by an arrow 36 to be discharged to the outside from the air exhaust ports 30 (the first flow path). The remaining airflow flows through the inside of the handle 4 as shown by an arrow 38, flows to the connection portion 5 from the back-end portion 4b of the handle 4, and is discharged to the outside from the air exhaust ports 30. Here, viewed in the axis A1 direction, a projection space 35, which is obtained by projecting a cross-sectional surface of the first flow path in the center position of the battery pack 100 in the front-back direction (a location shown by a height H1) upwind long the axis A1, is a range shown by dotted lines. Similarly, a projection space 37, which is obtained by projecting a narrowest portion (a part shown by a height H2 below the operation panel portion 20) of the handle 4 upwind along a central line of the wind path, is a range shown by dotted lines. In the example, the sound absorption material 33 is arranged in a position which does not overlap with the projection space 35, that is, outside (below) the projection space 35. The arrangement relation of the sound absorption material 33 has a positional relation of not overlapping with the projection space 37 either.

An upper-surface 33a viewed in the up-down direction of the sound absorption material 33 is formed in a flat surface, and is set to a position which is approximately the same as the position of an upper-surface of the rib 17c that is formed adjacently. The front-end surface 33b of the sound absorption material 33 is set to be in contact with a back-wall of the rib 17c. Similarly, a back-end surface 33c of the sound absorption material 33 is set to be in contact with a back-side inner-wall surface of the battery guard 26. In this way, the front-side part of the sound absorption material 33 is brought into contact with the rib 17c, and the back-side part is brought into contact with the wall surface of the battery guard 26, and thereby the backward movement of the sound absorption material 33 can be limited. In the example, because the long sound absorption material 33 is arranged in the front-back direction in the neighborhood of a bottom surface of the great-diameter wide space the housing 2, an effective sound absorption effect can be achieved. In addition, because the sound absorption material 33 can be stably held on the inner-wall part of the existing housing 2, assemblability during the manufacture is also excellent. Furthermore, because the upper-surface 33a of the sound absorption material 33 does not protrude to a side closer to the axis A1 than the rib 17c, the airflow flowing backward as shown by the arrow 36 from the motor holder 50 side is not disturbed in the wind path inside the projection space 35 (the first flow path). Furthermore, during the assembly of the housing 2 which is formed in the left-right manner division, the sound absorption material 33 can be stably fixed to the housing 2 only by being attached in an assembly process the same as conventional in which the sound absorption material 33 is mounted from the division surface to one side of the housing and joined and fixed to the housing.

As described above, in the third example, the sound absorption material 33 is arranged in a position which does not overlap with either of the first projection space shown by dotted lines 35 and the second projection space shown by dotted lines 37 (outside the projection spaces 35 and 37), and thus a satisfactory sound absorption effect can be achieved without disturbing the flow of the air inside the housing 2.

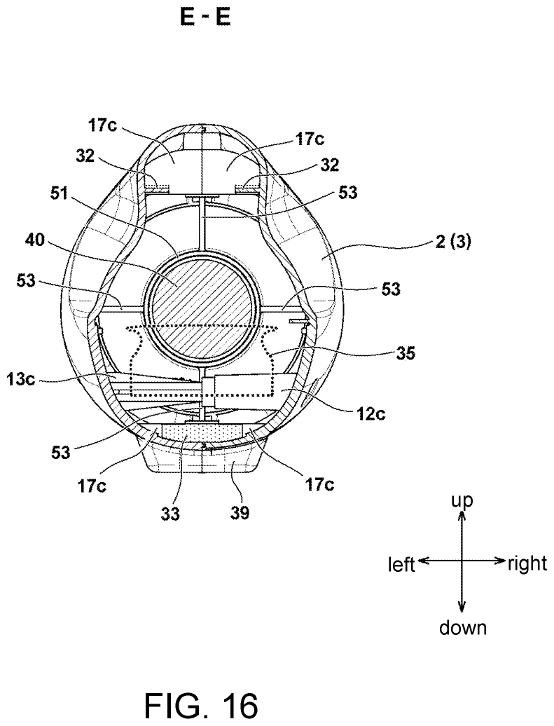

In the example, the sound absorption material may be arranged in still another location. The location is a space 34 which is located outside (above) the projection space 37 that is the second flow path. Because the space 34 is a dead space as a flow path, a sound absorption material the same as the sound absorption material 33 may be arranged. Below the space 34, ribs 32 horizontally extend from a left sidewall surface of the housing 2 and from a right sidewall surface, but do not reach the division surface because the protrusion widths of the ribs 32 in the left-right direction are respectively small (see FIG. 16 described later for the sizes of the protrusion widths). Thus, the sound absorption material can be arranged on an upper-side part of the ribs 32 or from an upper-side to a lower-side. According to the configuration, a further sound absorption effect can be achieved compared with that in a case in which the sound absorption material 33 is arranged only on the lower-side.

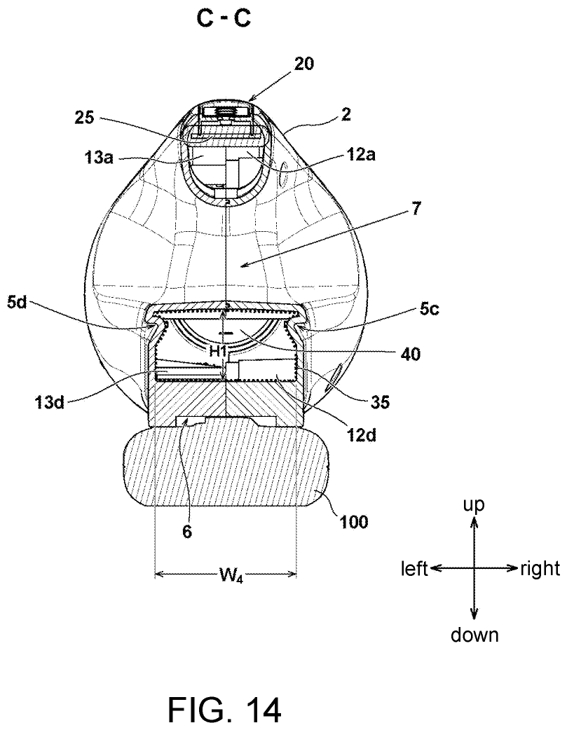

FIG. 14 is a cross-sectional view of a part taken along a C-C line of FIG. 11. The cross-sectional position is in front of the center position of the battery pack 100 in the axis direction. The shape of the first projection range 35 shown by the dotted lines is a cross-sectional shape of the connection portion 5 in the part taken along the C-C line. In the example, the size of a cross-sectional surface in the center position of the battery pack 100 in the axis direction is the same as the size of the cross-sectional surface of the part taken along the C-C line, and either of the above-described cross-sectional surfaces is a cross-sectional surface of a narrowest flow path inside the connection portion 5. As can be understood from FIG. 14 that the first projection space (projection region) 35 has a substantially rectangular shape having a long side in the horizontal direction. In both left and right side-surfaces of the connection portion 5, the recessed portions 5c and 5d which are continuous in the axis direction and are obliquely recessed inward are formed in the neighborhood of the upper part. Because the internal space of the connection portion 5 is set to a shape along the recessed portions 5c and 5d, parts which are recessed inward also exist in the first projection space 35. A lower-side of the first projection space 35 is a flat surface. A width W₄ of the first projection space 35 in the left-right direction is approximately equivalent to an interval of the rail grooves of the battery pack 100. Screw bosses 12d and 13d are formed on a front-side to cross the first projection space 35, but these screw bosses are arranged inside a wide space below the motor 40 and thus do not directly hinder the first flow path passing through the first projection space 35.

The internal space of the handle 4 is a space great in a longitudinal direction, but is sufficiently small compared with the first projection space 35 in a transverse direction. That is because the handle 4 is a part for the worker to grip with one hand, and operability will be damaged if the handle 4 is set to be wide. However, the inside of the handle 4 also can be used as the pathway of the air, which has an effect on the widening of the area of the wind path that only uses the first projection space 35, and thus the area of the wind path becomes sufficiently great compared with that in the cleaner in which the inner-side space of the handle 4 is not used as the pathway of the air.

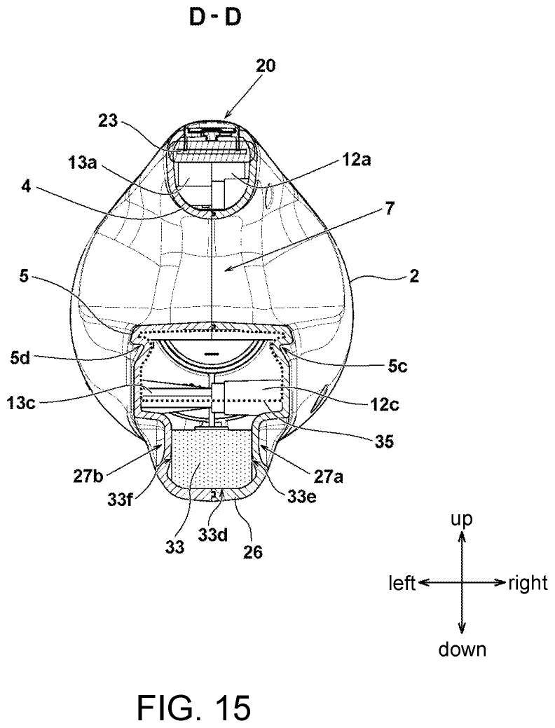

FIG. 15 is a cross-sectional view of a part taken along a D-D line of FIG. 11. The first projection space 35 shown by the dotted lines shows a cross-sectional surface in the neighborhood of the center of the battery pack 100 in the axis direction. Here, it can be understood that in the neighborhood of the part taken along the D-D line, the space of the housing 2 is enlarged downward from the projection surface 35, and additionally, a space (an internal space of a protrusion portion obtained due to the battery guard 26) exists which extends further downward than the enlarged region. In the example, the sound absorption material 33 is arranged so as to fill the internal space of the battery guard 26.

The sound absorption material 33 has a rectangular cross-sectional surface which is orthogonal to the axis A1. Both left and right sides of the bottom surface of the battery guard 26 are formed in circular-arc-shapes, but the sound absorption material 33 is a member such as a sponge having stretchability, and thus corner portions can be easily deformed, and a bottom surface 33d of the sound absorption material 33 can satisfactorily come into close contact with the inner-wall surface of the battery guard 26. Here, on both left and right sides of the battery guard 26, recessed portions 27a and 27b are formed which are recessed inward in curved-surface-like shapes from outer edge portions. By arranging these recessed portions 27a and 27b, inner-wall surfaces, which are in contact with a right-side side-surface 33e and a left-side side-surface 33f of the sound absorption material 33, become approximately vertical, and thus the sound absorption material 33 is satisfactorily in contact with and is clamped by the right-side inner-wall and the left-side inner-wall of the housing 2.

FIG. 16 is a cross-sectional view of a part taken along an E-E line of FIG. 11. It can be understood from the cross-sectional view that wide space is formed in the surrounding of the motor 40. Viewed in the rotation axis A1 direction of the motor 40, the first projection space 35 shown by the dotted lines has a positional relation of partially overlapping with the motor 40 and the fan 65 (see FIG. 7). However, in the arrangement space of the motor 40, great spaces are ensured in the surrounding of the first projection space 35, particularly on a right-side, a left-side, and a lower-side, and thus the air flows in a way that a lower-side part of the air which flows in the surrounding of the motor 40 is gathered from an outer-side of the first projection space 35 toward the first projection space 35 due to the cylinder-shaped internal shape of the housing 2. An upper-end position of the location in which the sound absorption material 33 is approximately the same as that of the rib 17c, and thus even if the sound absorption material 33 is arranged, the flow of the air from the fan 65 to the first flow path is not hindered. Meanwhile, because a part of the energy of the sound is attenuated by arranging the sound absorption material 33, the sound which is discharged to the outside from the air exhaust ports 30 can be reduced. In the example, a space other than regions which are used as the flow paths of the air, particularly a part (the inner-side space of the battery guard 26) which protrudes radially outward from the flow paths is used to efficiently arrange the sound absorption material 33, and thus the shape of the housing is not required to be redesigned to ensure a space for fixing the sound absorption material, and the operation sound can be reduced while the housing 2 of the first example is directly used. In general, the sound absorption effect can be increased by arranging a great number of sound absorption materials. However, even if the arrangement of the sound absorption material is partial, which means the sound absorption material 33 is arranged only in the neighborhood of a bottom surface on the inner-side of the housing 2, a sufficient sound absorption effect is achieved compared with that in a cleaner without sound absorption material.

According to the third example, because the sound absorption material 33 is clamped by the housing 2 which is formed in the left-right division type, the sound absorption material 33 can be arranged without changing the conventional assembly process. Moreover, because the sound absorption materials 33 are arranged outside the projection surface of the first flow path (the first projection space 35) and outside the second projection surface 37, the flow of the air inside the housing is not hindered, and thus there is no need for concern about the reduction of work efficiency of the cleaner. In addition, because the sound absorption material 33 is also inexpensive, the increase in the manufacture cost for the implement of the third example can be sufficiently suppressed.

As described above, the present invention is described based on the examples, but the present invention is not limited to the above-described examples, and various changes may be made without departing from the scope of the present invention. For example, the cleaner using the battery pack is taken as an example for description in the above-described examples, but the air exhaust structure of the cleaner according to the present invention can be similarly applied to a cleaner which has a power cord and is driven by a commercial power supply.

### REFERENCE SIGNS LIST

1, 1A cleaner
2, 2A housing
2a opening portion
3 motor accommodation portion
4 handle
4a front-end portion
4b back-end portion
5 connection portion
5c, 5d recessed portion
6 battery mounting portion
6a, 6b rail
7 penetration portion
8 terminal holder (terminal portion)
9, 9a to 9d main-body-side terminal
10 air intake port
11a fan room
11b motor accommodation room
11c connection room
11d handle space
12a to 12e screw boss
13a to 13e screw boss
14 leg portion
15 motor back-end holding portion
16 circular cylinder portion
16a groove portion
17a to 17c rib
18b rib
19a, 19b inserted hole
20 operation panel portion
21 “strong” mode button
22 “weak” mode button
23 “off” button
24 indicator lamp
25 control circuit substrate
26 battery guard
27a, 27b recessed portion
28 back-side of grip portion
29 back-side of battery pack
30 air exhaust port
31 auxiliary air exhaust port
32 rib
33 sound absorption material
33a upper-surface (sound absorption material)
33b front-end surface (of sound absorption material)
33c back-end surface (of sound absorption material)
33d bottom surface (of sound absorption material)
33e right-side side-surface (of sound absorption material)
33f left-side side-surface (of sound absorption material)
34 outer-side space
35 first flow path (first projection space)
36 air inflow direction
37 second flow path (second projection space)
38 air inflow direction
39 leg portion
40 motor
41 metal case
42 stator yoke
46 back-side shaft bearing holding portion
50 motor holder
51 internal cylinder portion
52 bottom surface portion
52a penetration hole
53 support plate
54 protrusion portion
55 external cylinder portion
56 rib
57 motor holder projection wind path
65 fan
66 circular ring plate
67 circular plate
68 blade
70 rubber bush
71 long-side sidewall portion
72 short-side sidewall portion
75 inserted hole
76, 77 inserted hole holding wall
78 link rib (hindering wall portion)
79 hollow portion
80 rubber cap
90 dust case
91 opening portion
92 nozzle
92a air exhaust path
93 convex portion
95 filter device
100 battery pack
101 latch button
102a, 102b rail groove
112 connection terminal
A1 output axis (of motor)
B1 rotation axis (of dust case)
C1 to C2 flow of sucked-in air
D1 perpendicular surface
E1 central line

1. A cleaner, comprising:
a housing which is cylinder-shaped;
a motor which is held inside the housing in a way that an output shaft faces a longitudinal direction;
a fan which is fixed to the output shaft and is used for generating a sucking force;
a battery pack which is fixed to the housing in a freely detachable way and supplies an electric power to the motor; and
a sound absorption material arranged inside the housing, wherein
the housing has:
an air intake port from which an airflow generated by rotation of the fan enters an inside of the housing;
an air exhaust port from which the airflow is discharged to an outside of the housing; and
a handle which is gripped by a worker, wherein
the air intake port is located in front of the motor in an axis direction of the output shaft,
the battery pack is located behind the motor in the axis direction,
the handle is located behind the motor in the axis direction and above the battery pack in an up-down direction intersecting the axis direction,
the air exhaust port is located between the handle and the battery pack, and the sound absorption material is arranged in a middle of a pathway from the fan to the air exhaust port.

2. The cleaner according to claim 1, wherein a dust case having a suction port that sucks powder dust is arranged in front of the fan of the housing, a connection portion to which the battery pack is connected is arranged at the back of the housing, and
the air exhaust port is arranged behind a center position of the battery pack in the axis direction.

3. The cleaner according to claim 2, wherein a portion of the housing placed behind the motor is substantially formed as D-shaped in a side view;
around a cavity surrounded by the portion formed as D-shaped, one side of the portion formed as D-shaped is the handle to be gripped by the worker, and
other side of the portion formed as D-shaped is the connection portion for the battery pack; and
a back-end of the handle and a back-end of the connection portion are connected, and thereby internal spaces of the handle and the connection portion are formed in a continuous way.

4. The cleaner according to claim 3, wherein the internal space of the connection portion is a first flow path of the airflow for guiding air, which is sucked into the housing from the dust case, to the air exhaust port by the fan, and
the internal space of the handle is a second flow path of the airflow for guiding the air to the air exhaust port by the fan.

5. The cleaner according to claim 3, wherein the handle has
a grip portion which extends along the axis direction, and
a bent portion which extends intersecting the axis direction and connects the grip portion and the connection portion; and
the bent portion is arranged in a way that a position of the bent portion in the axis direction overlaps with the air exhaust port.

6. The cleaner according to claim 5, wherein the grip portion has an operation portion which is operated by the worker to switch a drive of the motor, and
the operation portion has an operation panel portion which extends along the axis direction.

7. The cleaner according to claim 2, wherein a terminal portion which is electrically connected to the battery pack is arranged on the connection portion, and
a position of the terminal portion in the axis direction is between the fan and the air exhaust port.

8. The cleaner according to claim 1, comprising a control circuit substrate that controls a drive of the motor, wherein
the control circuit substrate is arranged inside the handle in a way that a surface extending direction is along the axis direction.

9. The cleaner according to claim 1, comprising an elastic body that is interposed between the housing and the motor to support a back-end side of the motor, wherein
a size of the elastic body in a radial direction is smaller than a diameter of the motor.

10. The cleaner according to claim 1, wherein an auxiliary air exhaust port is arranged in front of the air exhaust port of the housing to discharge a part of the airflow discharged from the fan to the outside of the housing.

11. The cleaner according to claim 1, wherein a sound absorption material is arranged outside a projection range which is formed in a way that a cross-sectional region of the housing in the center position of the battery pack in the axis direction is projected to a front-side in the axis direction along the axis direction.

12. The cleaner according to claim 11, wherein a thickness of the sound absorption material in a radial direction is set to a thickness at which the sound absorption material is accommodated outside the projection range.

13. The cleaner according to claim 11, wherein the sound absorption material is arranged on an inner-side of the housing in front of the battery pack in the axis direction.

14. The cleaner according to claim 11, wherein a rail mechanism and a hollow guard portion are formed on the connection portion of the housing, wherein the rail mechanism is for mounting the battery pack, and the hollow guard portion is in front of the rail mechanism in the axis direction and protrudes so as to cover half or more of a front-side sidewall of the battery pack; and
the sound absorption material is arranged on an inner-side of the hollow guard portion.

15. The cleaner according to claim 14, wherein the sound absorption material is arranged on a lower-side part of the housing in a way that a position of the sound absorption material in the axis direction is from a position partially overlapping with the motor to the hollow guard portion.

16. A cleaner, comprising:
a housing which is cylinder-shaped;
a motor which is held inside the housing in a way that an output shaft faces a longitudinal direction;
a fan which is fixed to the output shaft and is used for generating a sucking force; and
a battery pack which is fixed to the housing in a freely detachable way and supplies an electric power to the motor, wherein
the housing has:
an air intake port from which an airflow generated by rotation of the fan enters an inside of the housing;
an air exhaust port from which the airflow is discharged to an outside of the housing;
a handle which is gripped by a worker; and
a connection portion to which the battery pack is connected, wherein
the air intake port is located in front of the motor in an axis direction of the output shaft,
the battery pack is located behind the motor in the axis direction,
the handle is located behind the motor in the axis direction and above the battery pack into an up-down direction intersecting the axis direction,
the air exhaust port is located between the handle and the battery pack in the up-down direction, and
a cross-sectional area of the connection portion in a center position of the battery pack in the axis direction is greater than a cross-sectional area of the handle.
